(19) United States
(12) Patent Application Publication
(10) Pub. No.: US 2024/0120776 A1
(43) Pub. Date: Apr. 11, 2024

(54) Systems and Methods for Terrestrial Microwave Power Beaming Links

(71) Applicant: The Government of the United States of America, as represented by the Secretary of the Navy, Arlington, VA (US)

(72) Inventors: Christopher Rodenbeck, Washington, DC (US); James Park, Washington, DC (US); Brian Tierney, Washington, DC (US); Mark Parent, Washington, DC (US); Christopher Depuma, Washington, DC (US)

(21) Appl. No.: 18/375,505

(22) Filed: Sep. 30, 2023

Related U.S. Application Data
(60) Provisional application No. 63/412,264, filed on Sep. 30, 2022.

(51) Int. Cl. H02J 50/20; H02J 50/90; H04B 7/22

(52) U.S. Cl. CPC H02J 50/20; H02J 50/90; H04B 7/22

(57) ABSTRACT

Systems and methods are provided for power beaming that increase power density at the target location by exploiting scattering from terrain. The disclosed systems and methods further provide a variable focus feature allowing the beam power to be concentrated at specified standoff distances from the transmitter and increase the radio frequency (RF) power handling of the receiver using an overvoltage protection circuit in the DC load.

### CROSS REFERENCE TO RELATED APPLICATIONS

This application claims the benefit of U.S. Provisional Patent Application No. 63/412,264, filed on Sep. 30, 2022, which is incorporated by reference herein in its entirety.

### FEDERALLY SPONSORED RESEARCH AND DEVELOPMENT

The United States Government has ownership rights in this invention. Licensing inquiries may be directed to Office of Technology Transfer at US Naval Research Laboratory, Code 1004, Washington, DC 20375, USA; +1.202.767.7230; techtran@nrl.navy.mil, referencing Navy Case Number 211108-US2.

### FIELD OF THE DISCLOSURE

This disclosure relates to power systems, including microwave power systems.

### BACKGROUND

Microwave power beaming is the efficient point-to-point transfer of electrical energy across free space by a directive microwave beam. For example, a terrestrial ground-based microwave transmitter directed towards the horizon illuminates a rectenna (rectifying antenna) array that converts the incident microwave power to DC voltage.

Conventional terrestrial systems fail to sufficiently beam power across arbitrary terrain while minimizing structural costs. Embodiments of the present disclosure provide a power beaming system that can exploit the effect of “ground bounce” to enhance power density at the target location, even in the presence of irregular, inhomogeneous terrain.

### BRIEF DESCRIPTION OF THE DRAWINGS/FIGURES

The accompanying drawings, which are incorporated in and constitute part of the specification, illustrate embodiments of the disclosure and, together with the general description given above and the detailed descriptions of embodiments given below, serve to explain the principles of the present disclosure. In the drawings:

FIG. 1 is a diagram illustrating components in a terrestrial microwave power beaming link in accordance with an embodiment of the present disclosure;

FIG. 2A is a diagram illustrating design parameters for a power beaming link from a transmit (TX) aperture to a receive (RX) aperture across terrain in accordance with an embodiment of the present disclosure;

FIG. 2B is a diagram showing approximate 50%-power and 90%-power cross sections for a beam emanating from a transmit aperture focused at the far field distance and at half the far field distance in accordance with an embodiment of the present disclosure;

FIG. 3A is a diagram showing elevation above sea level at Blossom Point in accordance with an embodiment of the present disclosure;

FIG. 3B is a diagram showing elevation above sea level along a line of sight between the TX and RX locations in accordance with an embodiment of the present disclosure;

FIG. 4A shows a screenshot from a movie illustrating the variation in power density vs. height above ground as the transmitter tilt angle θₜᵢₗₜ scans over a ±1° range in accordance with an embodiment of the present disclosure;

FIG. 4B shows another screenshot from a movie illustrating the variation in power density vs. height above ground as the transmitter tilt angle θₜᵢₗₜ scans over a ±1° range in accordance with an embodiment of the present disclosure;

FIG. 5 shows diagrams illustrating peak power and 3-dB beam extent vs. tilt angle at dTRX=1046 m in accordance with an embodiment of the present disclosure;

FIG. 6 is a diagram that plots power density in accordance with an embodiment of the present disclosure;

FIG. 7 shows a diagram characterizing the transmit beam using a rotating source and fixed probe antenna and a diagram characterizing the transmit beam using a fixed source and a probe antenna able to translate within the plane of the receive aperture in accordance with an embodiment of the present disclosure;

FIG. 8A shows a diagram illustrating an experimental setup for characterizing the power beaming link where the reflector is configured as a transmitter in accordance with an embodiment of the present disclosure;

FIG. 8B shows a diagram illustrating an experimental setup for characterizing the power beaming link where the reflector is configured as a receiver in accordance with an embodiment of the present disclosure;

FIG. 8C is a diagram illustrating exemplary “ground bounce” focusing in accordance with an embodiment of the present disclosure;

FIG. 8D is a diagram illustrating exemplary variable focus zoom in accordance with an embodiment of the present disclosure;

FIG. 9 shows vertical and horizontal polarized radiation patterns in the azimuth (θ=0°) and elevation (ϕ=0°) planes for receiver heights of 5.5 m and 11 m in accordance with an embodiment of the present disclosure;

FIG. 10 shows measured and simulated relative power density vs. receiver height, confirming the increase in power due to the ground bounce effect in accordance with an embodiment of the present disclosure;

FIG. 11 shows measured radiation pattern of the focused beam pattern using the setup in FIG. 8A, with projected coordinates in the x-y plane and a map of power density in the receive plane using the setup in FIG. 8B, with projected coordinates in the ϕ-θ plane in accordance with an embodiment of the present disclosure;

FIG. 12 is a diagram illustrating that the transmit aperture is a 5.4-m-diameter parabolic reflector fed by a linearly actuated horn in accordance with an embodiment of the present disclosure;

FIG. 13 is a diagram showing variation in power at the center of the receive aperture, measured using the setup in FIG. 8A, for different feed displacements at the reflector antenna in accordance with an embodiment of the present disclosure;

FIG. 14 shows diagrams illustrating a measured radiation pattern of the defocused beam pattern and a map of power density in the receive plane in accordance with an embodiment of the present disclosure;

FIG. 15 shows diagrams illustrating an individual rectenna element and a rectenna tile in accordance with an embodiment of the present disclosure;

FIG. 16A is a diagram showing 24 rectenna tiles being assembled into a quadrant in accordance with an embodiment of the present disclosure;

FIG. 16B is a diagram showing the assembled quadrant of FIG. 16A with a protective radome installed in accordance with an embodiment of the present disclosure;

FIG. 17 is a block diagram showing use of overvoltage protection in the DC load to enhance survivability to excessive RF input power in accordance with an embodiment of the present disclosure;

FIG. 18A is a diagram showing output power and efficiency for a single rectenna tile vs. incident power density in accordance with an embodiment of the present disclosure;

FIG. 18B is a diagram showing output power and efficiency for the complete rectenna array assembled using the components shown in FIGS. 16A and 16B vs. incident power density in accordance with an embodiment of the present disclosure; and

FIG. 19 is a diagram illustrating test to destruction for the four quadrants of the rectenna array comparing the effectiveness of the TVS diode, Zener diode, and short circuit protection for improving input RF power handling in accordance with an embodiment of the present disclosure.

Features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

In the following description, numerous specific details are set forth to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an exemplary embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to understand that such description(s) can affect such feature, structure, or characteristic in connection with other embodiments whether or not explicitly described.

### 1. Overview

Embodiments of the present disclosure provide systems and methods for power beaming that: increase power density at the target location by exploiting scattering from terrain; provide a variable focus feature allowing the beam power to be concentrated at specified standoff distances from the transmitter; and increase the radio frequency (RF) power handling of the receiver using an overvoltage protection circuit in the DC load.

Embodiments of the present disclosure provide a mechanism to selectively focus the beam at specific, variable distances from the transmitter. Further, embodiments of the present disclosure describe a method that can increase the RF power handling capability of the receive aperture by >1 dB by adding an overvoltage protection circuit to its DC load.

### 2. “Ground Bounce” Focusing

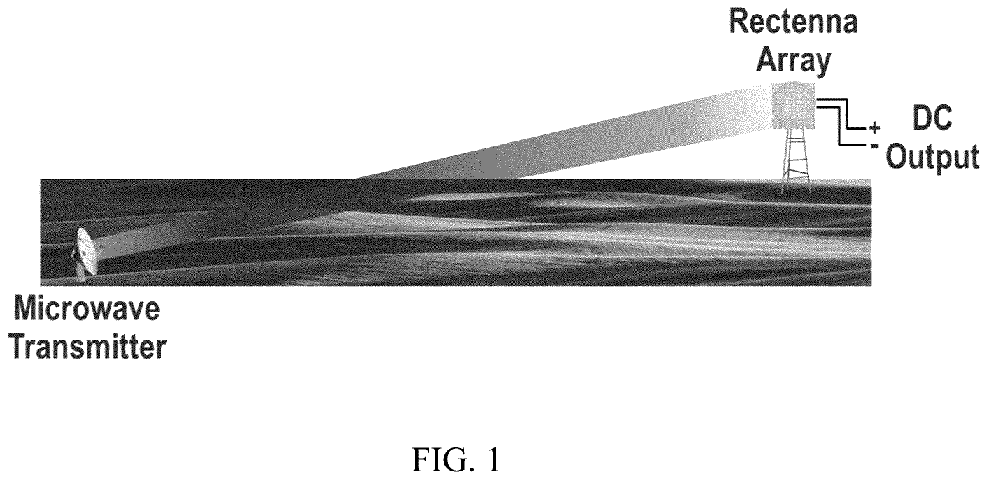

FIG. 1 is a diagram illustrating components in a terrestrial microwave power beaming link in accordance with an embodiment of the present disclosure. In FIG. 1, a ground-based microwave transmitter directed towards the horizon illuminates a rectenna (rectifying antenna) array that converts the incident microwave power to direct current (DC) voltage. Since microwave scattering from the terrain is a major design consideration, this application is therefore classified as terrestrial microwave power beaming.

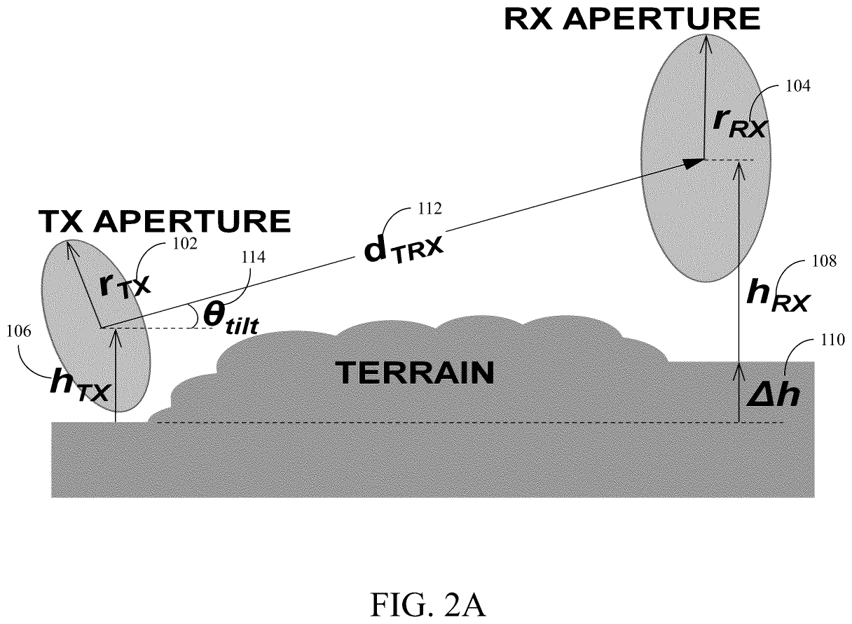

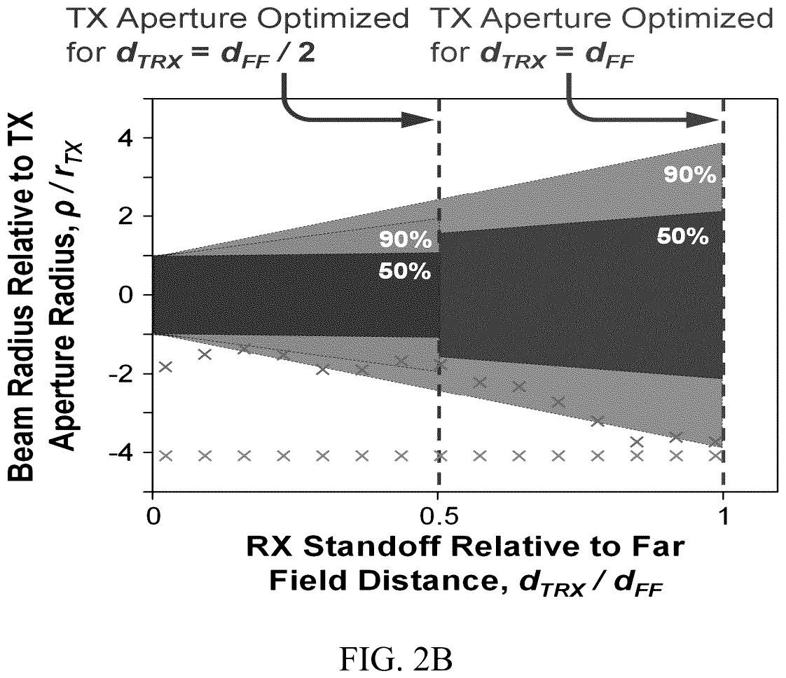

FIG. 2A is a diagram illustrating design parameters for a power beaming link from a transmit (TX) aperture to a receive (RX) aperture across terrain in accordance with an embodiment of the present disclosure. In FIG. 2A, relevant parameters include the transmit and receive aperture radii r_{TX} 102 and r_{RX} 104, the transmit and receive aperture heights h_{TX} 106 and h_{RX} 108 above the local ground, the difference in ground elevation at the transmit and receive locations Δh 110, and the distance between the transmit and receive apertures d_{TRX} 112. Although both apertures could have a tilt in elevation angle θₜᵢₗₜ 114, only the transmit aperture tilts in FIG. 2A.

A question for a terrestrial power beaming link is whether the effect of terrain scattering can be ignored without the need to perform a detailed analysis. Unfortunately, design rules of thumb such as Fresnel zones and popular approximations for mobile communications can be highly inaccurate for power beaming scenarios, producing overly conservative guidance for selecting antenna heights. As an alternative, the transmit beam can be approximated as a conic section extending from the transmit aperture to the target location. For a transmit aperture having an amplitude and phase distribution optimized to focus power at a distance d_{TRX}, the Gaussian beam approximation in Equation (1) can be used to estimate the beam radius ρ at d_{TRX}:

$$ρ = \frac{8}{π} \frac{{d}_{TRX}}{{d}_{FF}} {r}_{TX} \sqrt{ln ( \frac{1}{1 - η} )} \qquad ( 1 )$$

where d_{FF} is the transmit aperture's far field distance and η is proportion of the transmit power contained within ρ.

FIG. 2B is a diagram showing approximate 50%-power and 90%-power cross sections for a beam emanating from a transmit aperture focused at the far field distance and at half the far field distance in accordance with an embodiment of the present disclosure. In FIG. 2B, notional terrain profiles are plotted using “X” marks. FIG. 2B illustrates two cases in which the transmit aperture is optimized to focus power at the far field distance and half the far field distance, respectively. In both cases, conic sections approximating the beam are shown for 50% and 90% of the beam power. Note that the 50% and 90% beam radii can alternatively be estimated using the expected Fresnel-region 3-dB and 10-dB beam widths, respectively, if the transmit aperture distribution deviates significantly from the ideal distribution used to calculate Equation (1). Selected peaks of the surface topology can be plotted on this chart, with appropriate rotation if θₜᵢₗₜ≠0°. The figure illustrates that, even for power beaming over a flat surface, it can be necessary to significantly elevate the transmitter (or to up-tilt the transmitter and elevate the receiver) to prevent terrain from intruding into the 90% beam cross section. For long range links, the structural costs could be significant.

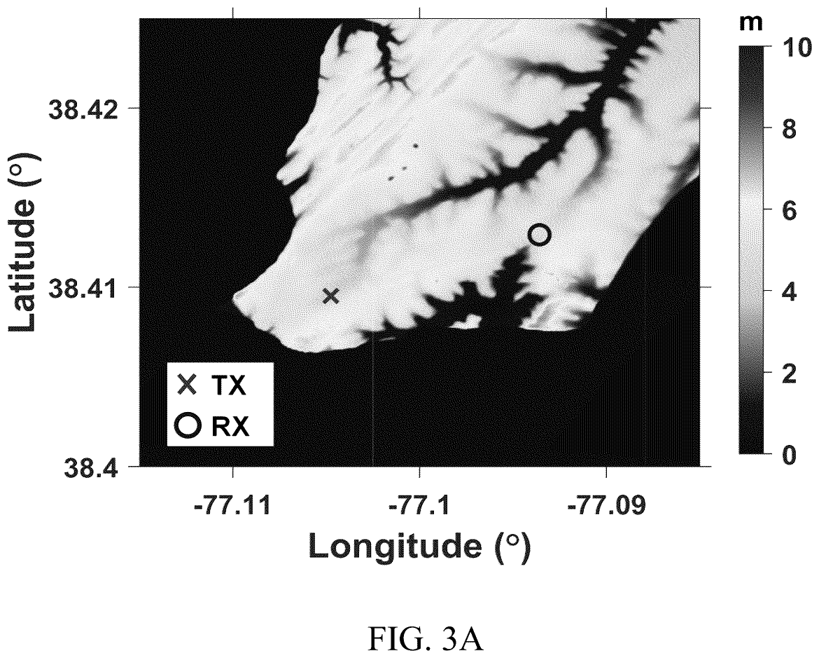

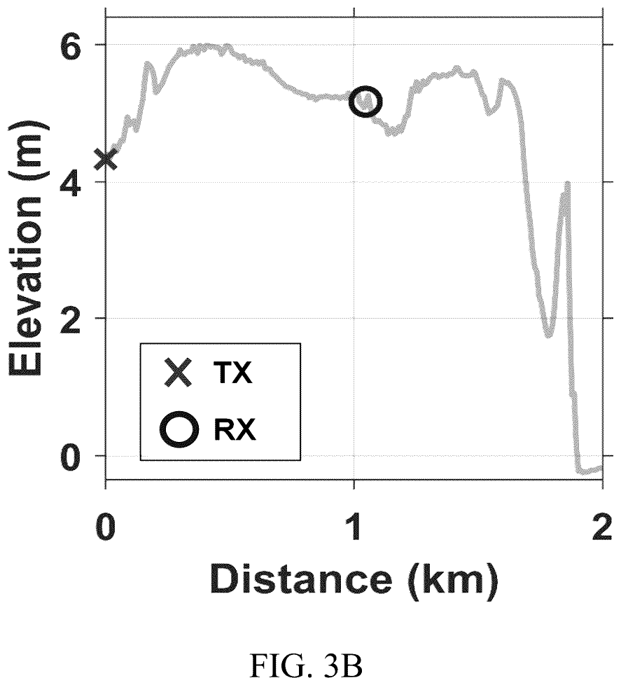

In an embodiment, the surface topography at the Blossom Point test site are used as a case study. FIG. 3A is a diagram showing elevation above sea level at Blossom Point in accordance with an embodiment of the present disclosure. FIG. 3A illustrates the Blossom Point test site using topographical data downloaded from the US Geological Survey. The elevation is referenced to the global mean sea level. The transmit and receive locations are separated by 1046 m. FIG. 3B is a diagram showing elevation above sea level along a line of sight between the TX and RX locations in accordance with an embodiment of the present disclosure. FIG. 3B illustrates the terrain profile along a line of sight from the transmitter to the receiver. The terrain along this contour is rugged and nonhomogeneous, consisting of moist grassland, rocky soil, a gravel roadbed, concrete pads, and abandoned metal detritus. The resolution of the data is ⅓ arcsec in latitude and longitude, with an accuracy, at 95% confidence in the presence of vegetation, of 58 mm in height.

Instead of constraining the geometry to minimize terrain scattering, it is possible to design a power beaming link to exploit scattering from terrain to achieve higher power density at the target location. The parabolic wave equation is a numerical method that can be used to explore propagation effects across terrain. Since this technique uses a paraxial approximation to the Helmholtz equation, it is valid in the Fresnel region and therefore well-suited for power beaming applications. In an embodiment, for the Blossom Point transmitter, r_{TX}=2.7 m, h_{TX}=3.71 m, d_{TRX}=1046 m, Δh=0.8 m, and r_{TX} should be sized based on the predicted beam spotlight at dTRX. FIG. 3A specifies the terrain, and h_{RX} and θₜᵢₗₜ are the design parameters.

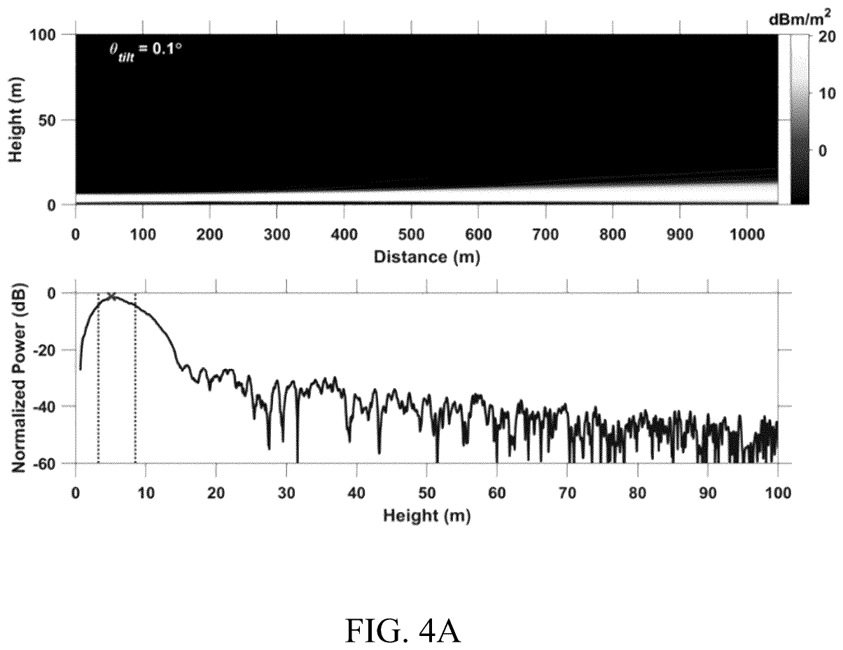

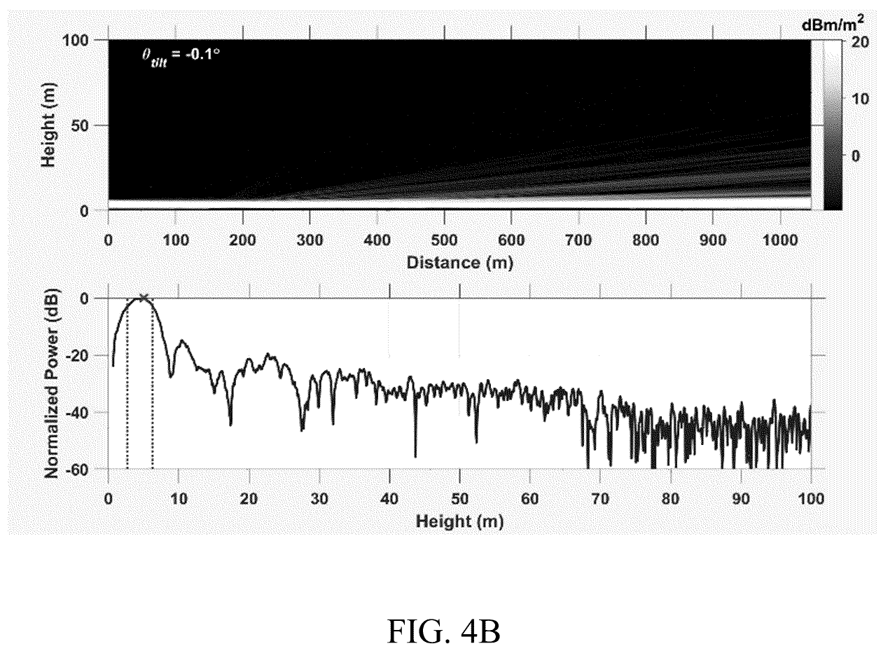

FIG. 4A shows a screenshot from a movie illustrating the variation in power density vs. height above ground as the transmitter tilt angle θₜᵢₗₜ scans over a ±1° range in accordance with an embodiment of the present disclosure. FIG. 4 shows a beam cross section for a transmit power of 1 W. As the beam passes through the ±0.1° range, the ground scattering enhances power density at the target location. The graph in FIG. 4 shows power density vs height at d_{TRX}=1046 m normalized to the angle of maximum response, with peak and 3-dB points indicated. FIG. 4 illustrates the variation in power density vs. height at d_{TRX}=1046 m as θₜᵢₗₜ scans from +1° to −1°. The height above ground is referenced to a zero at the location of the transmitter, and the soil is assumed to be uniform and dry with 0.67 S/m conductivity and a relative dielectric constant of 25.916. As the beam passes through the ±0.1° range, the ground scattering actually improves the beam focus at the target location. Note that the approximations in this analysis include a reduction of the terrain model to a homogeneous 2-D cross section. FIG. 4B shows another screenshot from a movie illustrating the variation in power density vs. height above ground as the transmitter tilt angle θₜᵢₗₜ scans over a ±1° range in accordance with an embodiment of the present disclosure. In FIG. 4A, θₜᵢₗₜ is 0.1°, and FIG. 4B, θₜᵢₗₜ is −0.1°

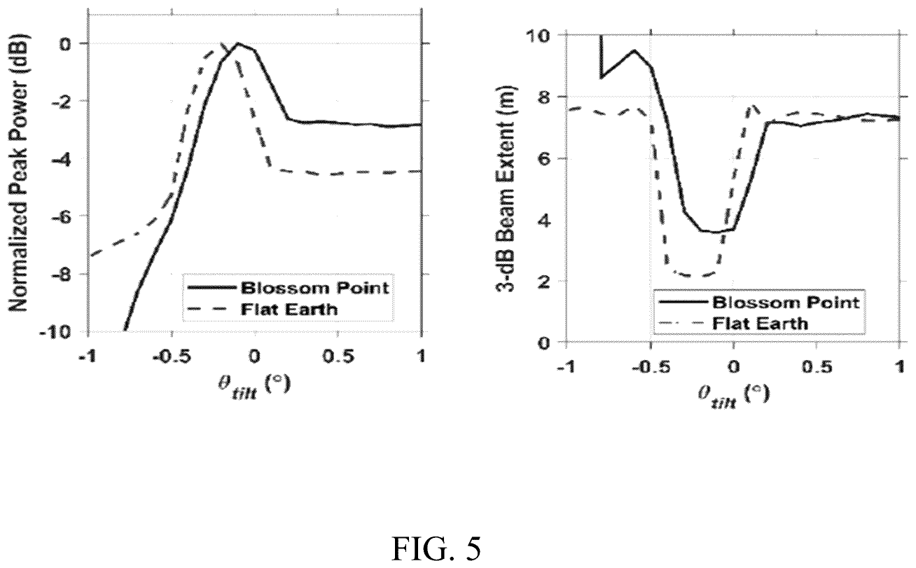

FIG. 5 shows diagrams illustrating peak power and 3-dB beam extent vs. tilt angle at dTRX=1046 m in accordance with an embodiment of the present disclosure. In FIG. 5, results over a flat earth are provided for comparison. FIG. 5 calculates the peak power and 3-dB beam extent over the θtilt=±1° range for the Blossom Point terrain, predicting a 2.73 dB increase in maximum power density for θₜᵢₗₜ=−0.2° to +0.1°. The results over perfectly flat terrain, provided for comparison, show a >4 dB improvement is possible. Modifying the simulation so that flat earth is perfectly conducting increases the “ground bounce” effect to 5.75 dB, which approaches the theoretical limit of 6 dB.

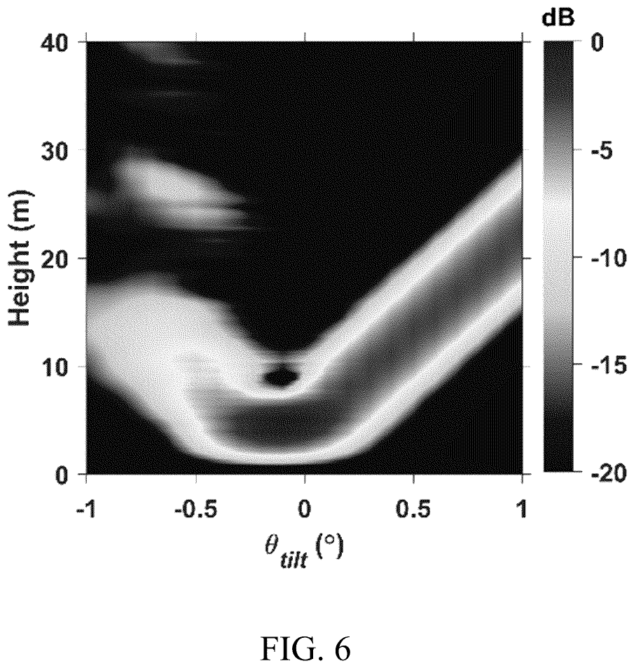

FIG. 6 is a diagram that plots power density in accordance with an embodiment of the present disclosure. For example, FIG. 6 plots the power density at d_{TRX}=1046 m vs. height (h_{RX}+Δh) and vs. θₜᵢₗₜ, showing that the optimum receiver height is 5 m over a −0.2° to +0.1° range of transmitter tilt angles θₜᵢₗₜ. The result is normalized to the peak response. FIG. 6 plots the power density as a function of height relative to the transmitter ground level (h_{RX}+Δh) and θₜᵢₗₜ to graphically represent the optimum link geometry. For the Blossom Point link, a receiver height of 5 m is optimal over a θₜᵢₗₜ=−0.2° to +0.1° range of transmitter tilt angles. Referencing these parameters to the diagram in FIG. 5, θtilt=+0.1° provides a direct line of site to h_{RX}=5 m, indicating that the optimum geometry uses this height with a slight downward tilt from the line of sight. This result is not general, however. Although not shown here, the optimal choice of receiver height and transmitter tile can be sensitive to small variations in link distance d_{TRX}. The analysis in FIGS. 5 and 6 should be repeated or parameterized vs. d_{TRX} if standoff distance is a design variable.

### 3. Exemplary Systems for “Ground Bounce” Focusing

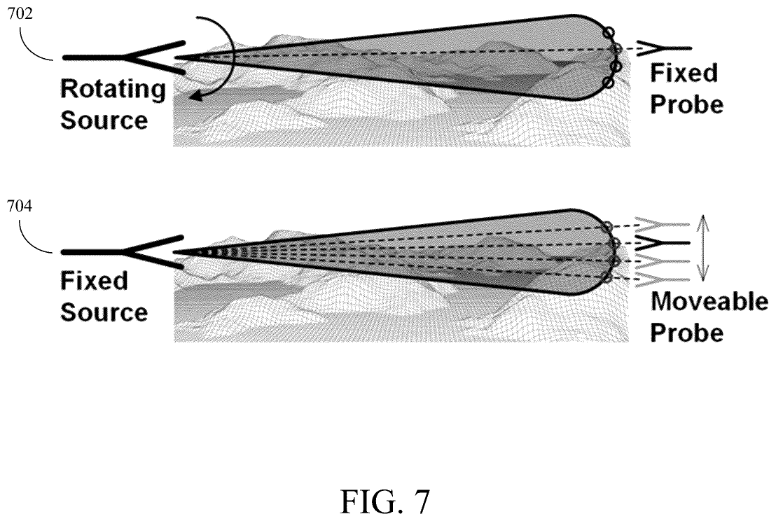

Terrain scattering impacts the measurement strategy for characterizing power density, and therefore efficiency, of a power beaming link. FIG. 7 illustrates two possible approaches. FIG. 7 shows a diagram characterizing the transmit beam using a rotating source and fixed probe antenna and a diagram characterizing the transmit beam using a fixed source and a probe antenna able to translate within the plane of the receive aperture in accordance with an embodiment of the present disclosure. In an embodiment, the measurements are not equivalent since the method using a rotating source samples the multipath along a single line of sight. In the case of a rotating source 702, a stationary field probe samples received power as the microwave source rotates in angle. In the case of a fixed source 704, the microwave source remains fixed while the field probe translates linearly to sample power in the receive plane. In free space or in an anechoic chamber, the two techniques yield equivalent results. In the presence of terrain scattering, however, the approach in 702 samples all the points of the radiation pattern along the same line of sight and thus cannot capture the true variation in terrain scattering across the receive aperture. Even for highly directive transmit sources, scattering from terrain can be significant, making it necessary to spatially sample the beam, as shown in 704, to accurately determine the incident power. The approach in 702 nonetheless does have physical meaning, from the standpoint of beam alignment, as the representation of the variation in rectenna output power as the transmitter scans its beam in angular space.

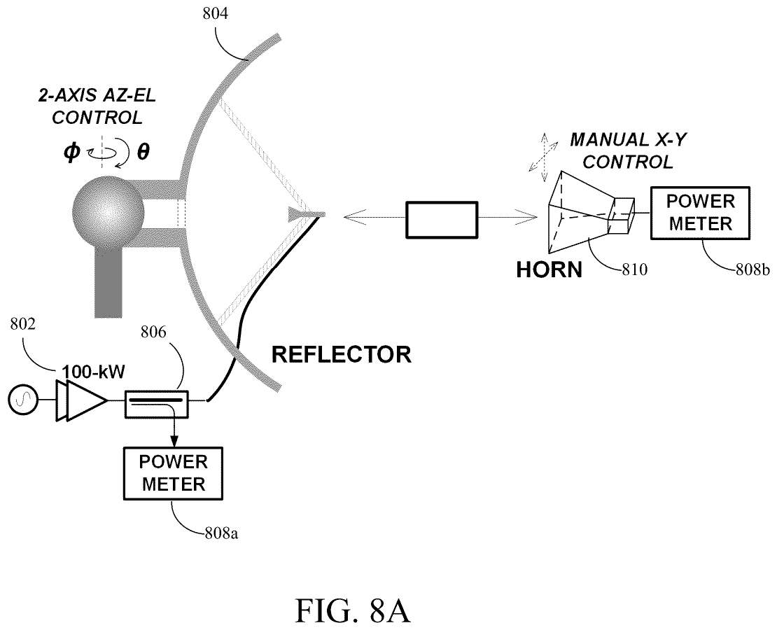

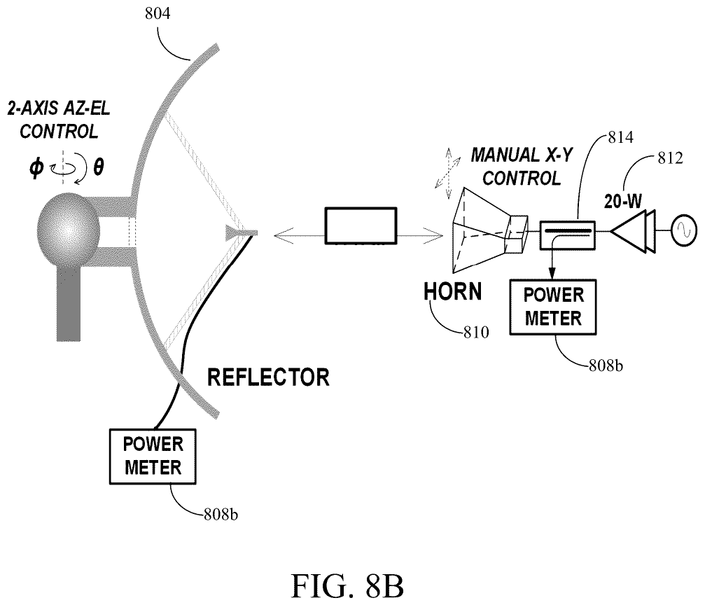

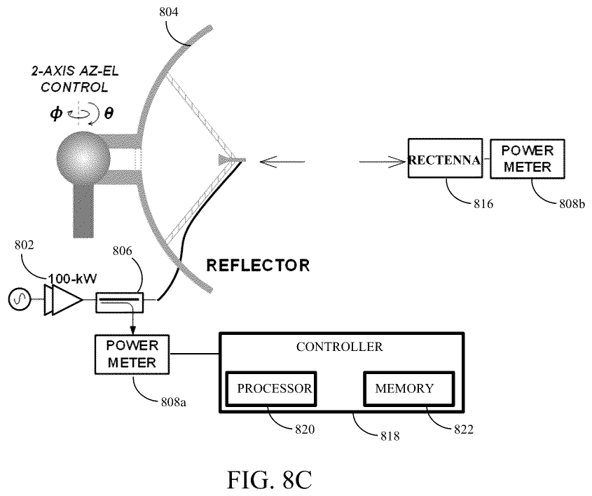

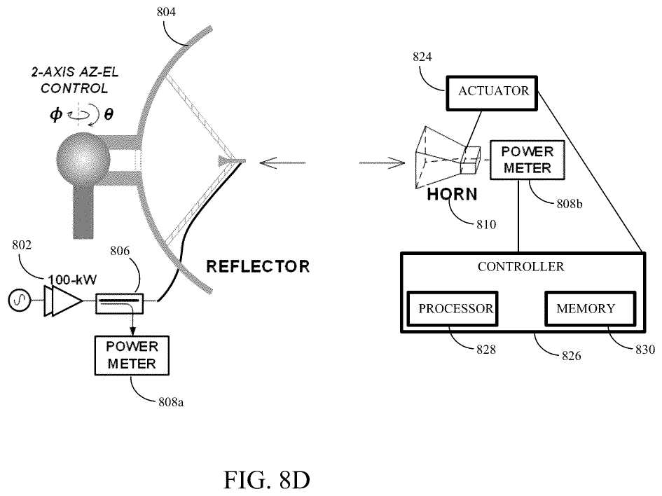

In an embodiment, the measurement approaches shown in FIG. 7 702 and 704 can be executed using an experimental setup that allows a horn antenna to translate to any position in the plane of the receive aperture over a ±1.5 m range in the horizontal dimension and over a 4 to 7 m range above ground in the vertical dimension. FIGS. 8A and 8B illustrate two experimental setups used to characterize the beam produced by the transmitter. FIG. 8A shows a diagram illustrating an experimental setup for characterizing the power beaming link where the reflector is configured as a transmitter in accordance with an embodiment of the present disclosure. FIG. 8B shows a diagram illustrating an experimental setup for characterizing the power beaming link where the reflector is configured as a receiver in accordance with an embodiment of the present disclosure.

In FIG. 8A, a 100-kW pulsed power amplifier (PA) 802 feeds a 5.4-m reflector antenna 804. In an embodiment, the connection between the PA 802 and reflector feed for reflector 804 is a WR-90 rectangular waveguide 806. In an embodiment, a power meter 808a is coupled to the rectangular waveguide 806. In FIG. 8A, a horn 810 (e.g., in an embodiment, a calibrated horn) samples the power density at a standoff (e.g., in an embodiment, a 1046-m standoff) from the reflector 804. In an embodiment, the horn 810 has 10.95 dBi gain at 9.73 GHz. In an embodiment, a power meter 808b is coupled to the horn 810. The reflector 804 can scan in azimuth ϕ and elevation θ, while the horn 810 can translate in x and y in the plane of the receive aperture. In an embodiment, power meters 808a and 808b are LadyBug LB680A power meters that sample the power at both sites. In the second setup, shown in FIG. 8B, the link is reversed so that a 20-W continuous wave (CW) PA 812 drives the horn antenna, and the reflector 804 receives the power. In an embodiment, a rectangular waveguide 814 is used to couple the PA 812 to the horn 810. Since the antenna directivities and terrain scattering are identical in both setups, cross checking between the two approaches makes it possible to identify and eliminate errors in deembedding system losses.

FIG. 8C is a diagram illustrating exemplary “ground bounce” focusing in accordance with an embodiment of the present disclosure. In FIG. 8C, reflector is configured to transmit a signal to a rectenna 816 (or to an antenna), which can optionally be coupled to a power meter 808b. In FIG. 8C, optional power meter 808a is coupled to a controller 818. In an embodiment, controller 818 includes a processor 820 and a memory 822. In an embodiment, controller 818 is configured to receive information from power meter 808a and power meter 808b or rectenna 816 (e.g., via a wireless communication link). In an embodiment, this information includes information regarding power sampled by power meters 808.

In an embodiment, controller 818 receives information from power meter 808b or rectenna 816 indicating power and/or voltage received by rectenna 816. Based on this information, controller 818 can determine a positional adjustment (e.g., an optimal tilt for reflector antenna 804 and/or an optimal height for reflector antenna 804) that will result in the most power received by rectenna 816. In an embodiment, controller 818 can transmit a signal to reflector antenna 804 instructing reflector antenna 804 to adjust its tilt and select a tilt angle to produce the most power on the receive side (e.g., the most power received by rectenna 816). In an embodiment, controller 818 can transmit a signal to reflector antenna 804 instructing reflector antenna 804 to adjust its height to produce the most power on the receive side (e.g., the most power received by rectenna 816). In an embodiment, controller 818 can transmit a signal to reflector antenna 804 instructing reflector antenna 804 to adjust its tile angle and its height to produce the most power on the receive side (e.g., the most power received by rectenna 816).

In an embodiment, controller 818 can transmit a signal to rectenna 816 (or to an antenna on the receive side) instructing rectenna 816 to adjust its height to produce the most power on the receive side (e.g., the most power received by rectenna 816). In an embodiment, this signal can be sent over a wireless or wired link to rectenna 816. In an embodiment, controller 818 can instruct reflector 804 to send this signal to rectenna 816. While controller 818 is shown on the reflector side in FIG. 8C, it should also be understood that controller 818 could also be located on the rectenna side in accordance with embodiments of the present disclosure. For example, in an embodiment, controller 818 can be coupled to power meter 808b or rectenna 816 instead of to power meter 808a. FIG. 8D is a diagram illustrating exemplary variable focus zoom in accordance with an embodiment of the present disclosure and will be discussed later with respect to variable focus zoom.

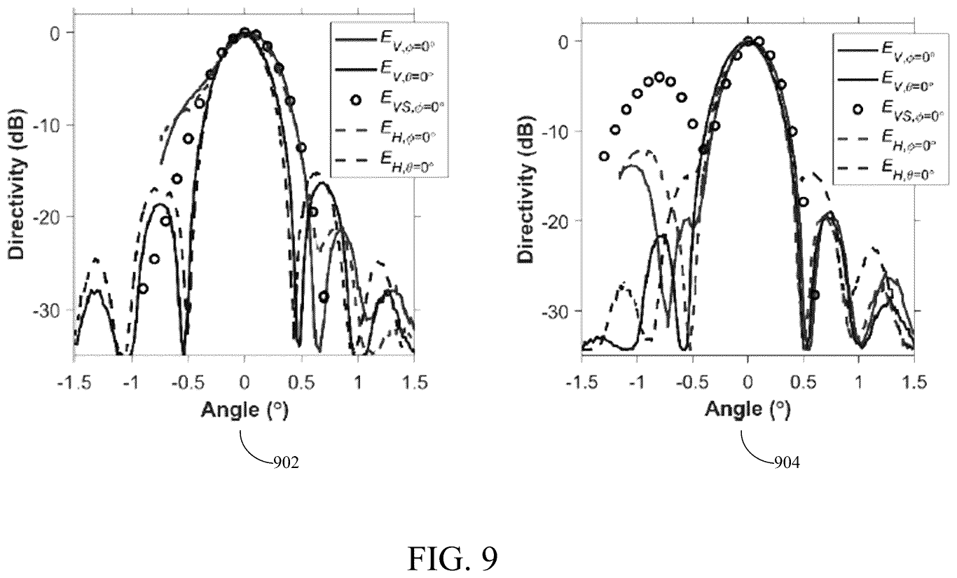

In an embodiment, measuring the radiation pattern of the reflector antenna at multiple heights on the receive tower confirms the impact of terrain effects on the beam shape. FIG. 9 shows vertical and horizontal polarized radiation patterns in the azimuth (θ=0°) and elevation (ϕ=0°) planes for receiver heights of 5.5 m and 11 m in accordance with an embodiment of the present disclosure. Simulated results Evs, ϕ=0° accounting for surface topography closely match the main beam shape in the elevation plane. FIG. 9 shows the azimuth (θ=0°) and elevation (ϕ=0°) cuts of the reflector's radiation pattern when the antennas are oriented for both vertical (EV) and horizontal (EH) polarization measured using the first setup 902 in FIG. 9. The reflector is boresighted to the horn at (hRX+Δh)=5.5 m and 11.0 m in setups 902 and 904 of FIG. 9, respectively. For the elevation scans at the lower horn height, the reflector's range of travel is limited for elevations angles θ<−0.75°. The measured radiation patterns for vertical and horizontal polarization match closely, as expected for very low grazing angles. The parabolic equation simulation for the designed source distribution oriented for vertical polarization in the ϕ=0° plane (EVS, ϕ=0°) shows excellent agreement with the measured main beam shape for both vertical and horizontal polarizations; outside the main beam, a large side lobe predicted in 904 is much reduced in experimental results. For concision, only vertically polarized results are illustrated in the remaining figures and tables of this disclosure.

Table 1 provides a comparison between measured, simulated, and optimal values for the half-power beam width (HPBW). Table 1 compares the measured half power beam width (HPBW) with simulated values for the designed aperture distribution EVS, ϕ=0°. Measured HPBW matches closely with simulated HPBW in the ϕ=0° plane and with free space HPBW in the θ=0° plane. For simplicity, only vertically polarized results are shown.

TABLE 1

| | HPBW at | HPBW at | HPBM in free |
|---|---|---|---|
| Pattern Cut | h_{RX} = 5.5 m | h_{RX} = 11 m | space |
| E_{V, ϕ=0°} | 0.50 | 0.40 | — |
| E_{V, θ=0°} | 0.40 | 0.42 | — |
| E_{VS, ϕ=0°} | 0.51 | 0.41 | 0.40 |

It is possible to determine the optimal receiver height at 1046 m standoff from the reflector by varying the height of the horn (or, in an embodiment the rectenna), boresighting the horn and reflector at each height, and measuring received power. In an embodiment, it is possible to determine the optimal receiver tilt angle by varying the height of the horn (or, in an embodiment the rectenna) and measuring received power at a plurality of tilt angles. In an embodiment, controller 8C can send instructions to adjust the rectenna 816 or horn 810 to a plurality of possible heights and/or tilt angles, determined received power at each respective height and/or tilt angle, and determined an optimum height and/or tilt angle based on the results.

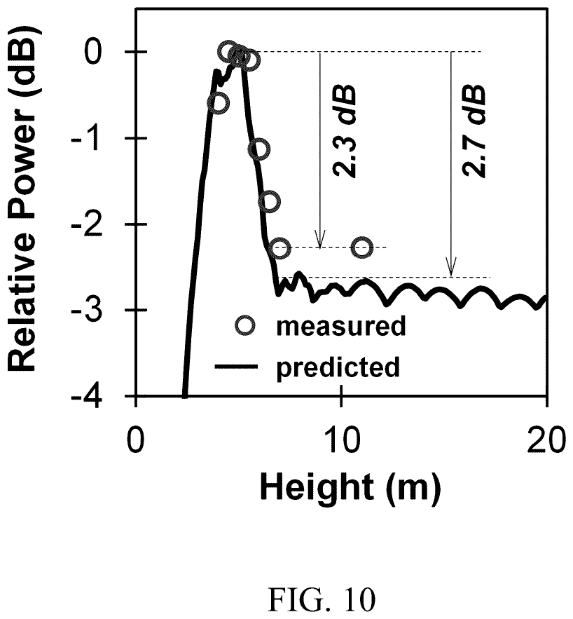

FIG. 10 shows measured and simulated relative power density vs. receiver height, confirming the increase in power due to the ground bounce effect in accordance with an embodiment of the present disclosure. In an embodiment, FIG. 10, compares the result of this experiment with simulation. A sharp increase in received power is evident in the 4.5-5.5 m range, as predicted by simulation. The measured enhancement due to “ground bounce” is 2.3 dB, which although slightly less than the predicted value of 2.7 dB, nonetheless confirms the importance of terrain scattering in the design of terrestrial power beaming links.

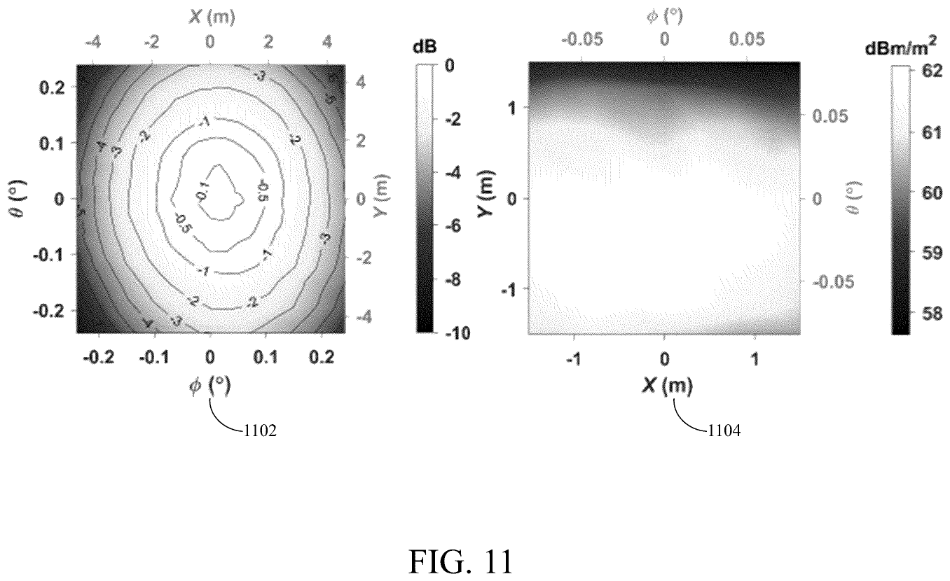

FIG. 11 shows measured radiation pattern of the focused beam pattern using the setup in FIG. 8A, with projected coordinates in the x-y plane and a map of power density in the receive plane using the setup in FIG. 8B, with projected coordinates in the ϕ-θ plane in accordance with an embodiment of the present disclosure. FIG. 11 compares the measured radiation pattern determined via scanning over a ±0.24° range in azimuth ϕ and elevation θ with the measured power intensity determined by varying x-y position in the receive aperture over a ±1.5 m range. The first 1102 and second 1104 diagrams in FIG. 11 show projected coordinates in the x-y and ϕ-θ dimensions, respectively, for comparison. Increased variation in power density vs. height is clear in the second diagram 1104, as predicted from the results in FIG. 10, confirming the importance of spatial sampling of the received field for the accurate determination of the incident power at the receive aperture. The peak power density is 1643 W/m2.

### 4. Variable Focus Zoom

In an embodiment, the transmit aperture shown in FIGS. 8A and 8B is a 5.4-m-diameter parabolic reflector originally designed as a Cassegrain antenna but reconfigured to use a standard axial feed. In an embodiment, the reflector's focal length is 2 m. In an embodiment, the feed is a horn that illuminates the reflector with a 17 dB amplitude taper from the center to the edge.

In an embodiment, the feed horn is mounted on a linear actuator that allows the feed location to vary over a 100 mm range along the reflector's axis. Displacing the feed in this way creates a quadratic phase error across the reflector that can be used to concentrate the power in the transmit beam at specific near field distances along the main beam axis. Embodiments of the present disclosure provide methods that enable a capability to focus and finely adjust power density at a near-field target location even in the presence of significant terrain scattering.

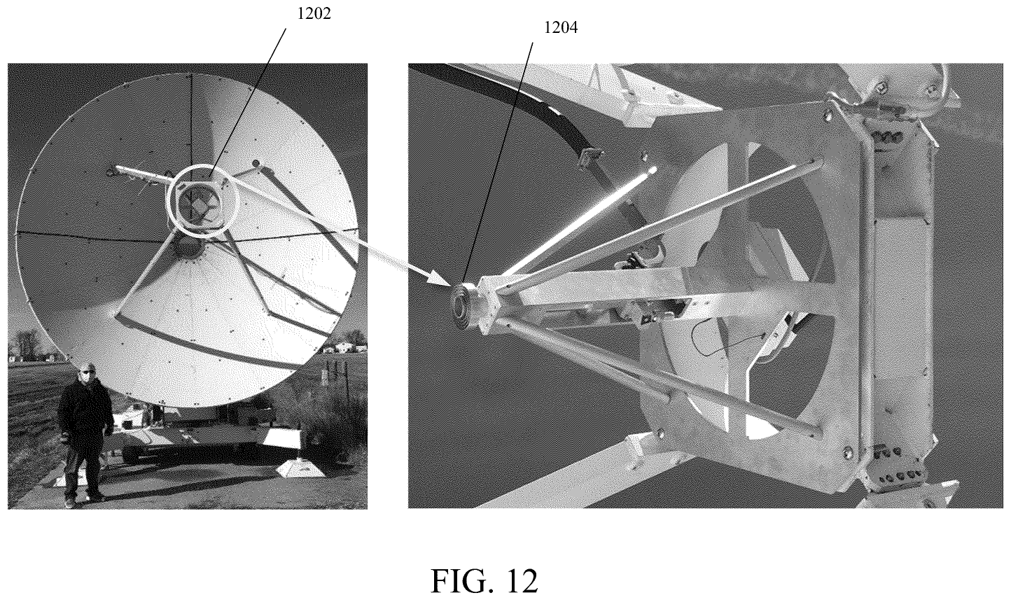

FIG. 12 is a diagram illustrating that the transmit aperture is a 5.4-m-diameter parabolic reflector fed by a linearly actuated horn in accordance with an embodiment of the present disclosure. In FIG. 12, parabolic reflector 1202 is fed by linearly actuated horn 1204. Varying the feed location makes it possible to focus the beam at specific standoff distances from the transmitter.

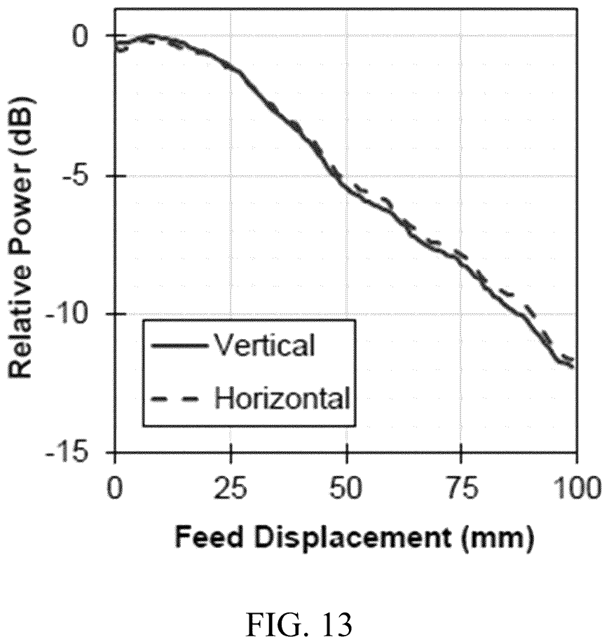

FIG. 13 is a diagram showing variation in power at the center of the receive aperture, measured using the setup in FIG. 8A, for different feed displacements at the reflector antenna in accordance with an embodiment of the present disclosure. Controlling the feed displacement defocuses the beam, making it possible to control the power density incident on the rectenna.

As shown in FIG. 13, the linearly actuated feed can defocus the beam, providing a mechanism for controlling power density over a >10 dB range. FIG. 13 illustrates the power density at the plane of the rectenna array with the feed defocused at a displacement of 40 mm. This ability to mechanically focus/defocus the beam is analogous to a variable focus “zoom” feature on a camera or projector.

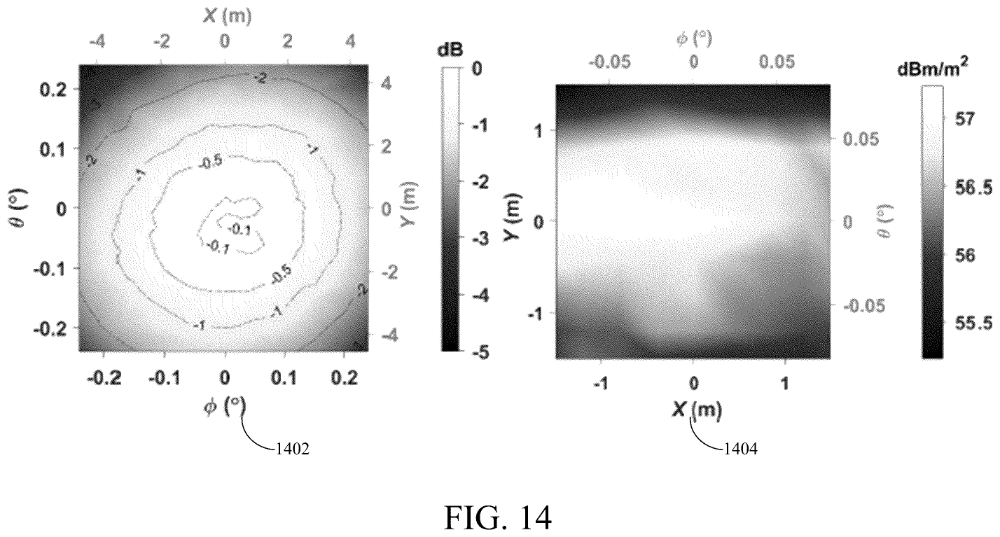

FIG. 14 shows diagrams illustrating a measured radiation pattern of the defocused beam pattern and a map of power density in the receive plane in accordance with an embodiment of the present disclosure. The first diagram 1402 in FIG. 14 shows measured radiation pattern of the defocused beam pattern using the setup in FIG. 8A, with projected coordinates in the x-y plane. The second diagram 1404 in FIG. 14 shows a map of power density in the receive plane using the setup in FIG. 8B, with projected coordinates in the ϕ-θ plane. Power density in the center of the x-y plane is 552 W/m².

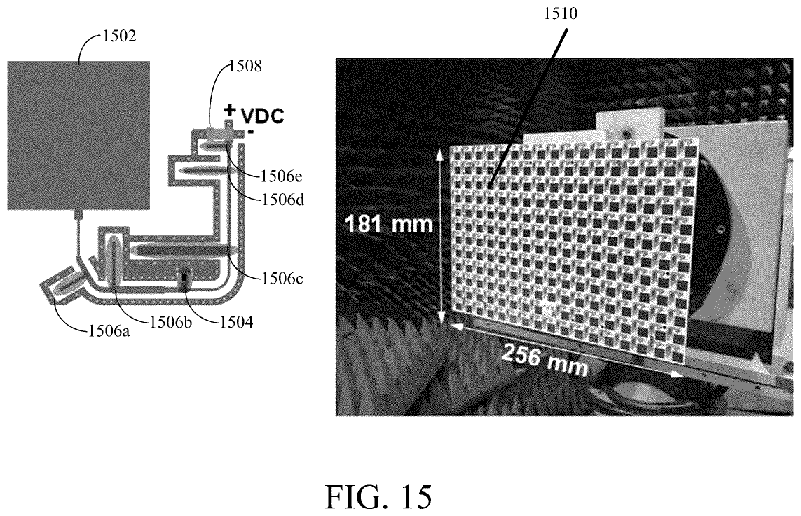

FIG. 8D is a diagram illustrating exemplary variable focus zoom in accordance with an embodiment of the present disclosure. In FIG. 15, an actuator 824 is coupled to, or, in an embodiment, a component of, horn 810 (e.g., in an embodiment a linearly actuated horn). In an embodiment, actuator 824 is configured to adjust a position of horn 810. In an embodiment, a controller 826 is coupled to optional power meter 808b and/or actuator 824. In an embodiment, controller 826 includes a processor 828 and a memory 830.

In an embodiment, controller 826 is configured to receive information from power meter 808a, power meter 808b, and/or horn 810 regarding the power received at horn 810. Based on this information, controller 826 is configured to send a signal to actuator 824 to adjust a position of calibrated horn 810 such that power received at horn 810 is maximized.

In an embodiment, horn 810 can be replaced by a rectenna coupled to actuator 824. In an embodiment, controller 826 is configured to send a signal to actuator 824 to adjust a position of the rectenna such that power received at the rectenna is maximized. While controller 826 is shown on the right side in FIG. 8D, it should be understood that controller 826 can also be located on the left side in accordance with embodiments of the present disclosure. For example, in an embodiment, controller 826 is coupled to power meter 808a (e.g., as shown in FIG. 8C).

In an embodiment, controller 826 can determine power received at different displacements of horn 810 or rectenna 816. For example, in an embodiment, controller 826 can send a plurality of signals to actuator 824 that instruct actuator 824 to adjust horn 810 and/or rectenna 816 to a plurality of respective positions, receive power measurements from power meter 808b at each position, and determine an optimal position for horn 810 or rectenna 816 based on these measurements.

### 5. Increasing Receive Power Handling

The power beaming receiver is called a rectenna (i.e., a “rectifying antenna”). FIG. 15 shows diagrams illustrating an individual rectenna element and a rectenna tile in accordance with an embodiment of the present disclosure. In FIG. 15, the individual rectenna element includes microstrip a patch antenna 1502, a Shottky diode 1504, a plurality of matching and harmonic tuning features 1506, and a capacitor 1508. In an embodiment, the DC output of a plurality (e.g., in an embodiment, 203) rectenna elements combine to form a rectenna tile 1510 (e.g., in an embodiment, a 181 mm×256 mm rectenna tile). In an embodiment, the DC connections take place on lower substrate layers.

As an example, the rectenna array used in an exemplary demonstration of an embodiment of the present disclosure is based on the individual rectenna element shown in FIG. 15. In an embodiment, the element includes: a microstrip patch antenna 1502 fabricated using 18-μm-thick copper on a 0.51-mm Rogers 3003 substrate; a MACOM MA4E1317 Schottky diode 1504; and microstrip features 1506 for impedance matching and harmonic tuning at 9.7-GHz as well as the 2nd and 3rd harmonics. In an embodiment, a 2-pF capacitor 1508 is also included to filter out any RF power not reflected by the harmonic stubs. In an embodiment, on lower substrate layers, the DC outputs from 17 rows of 12 parallel-connected elements combine in series to form the 181 mm×256 mm 203-element tile shown in FIG. 15. In an embodiment, 4 rows of 6 parallel-connected tiles combine in series to form a 1.02 m×1.09 m rectenna quadrant.

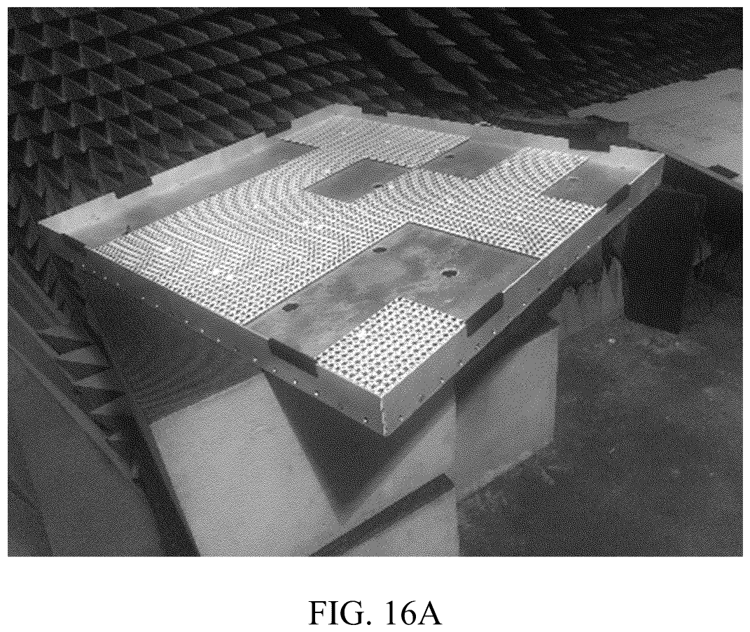

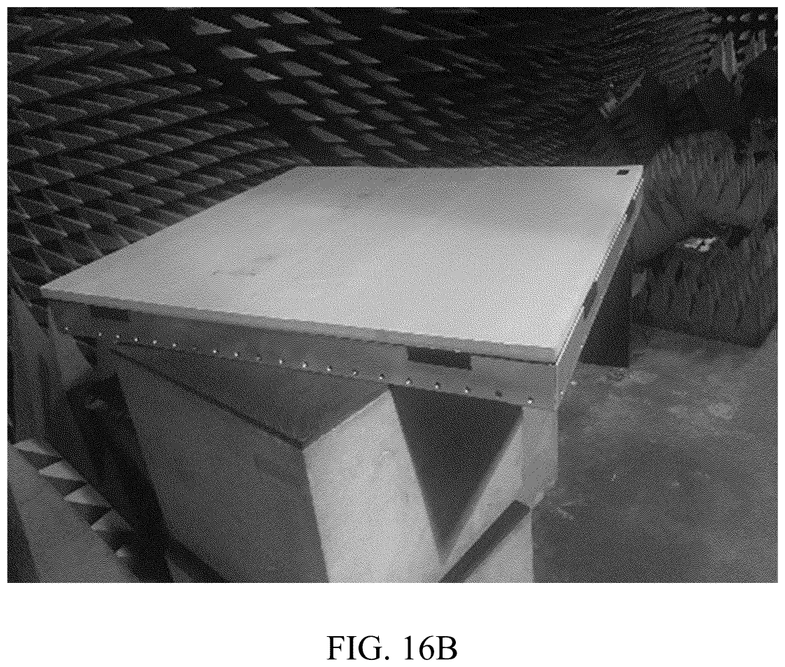

FIG. 16A is a diagram showing 24 rectenna tiles being assembled into a quadrant in accordance with an embodiment of the present disclosure. FIG. 16A illustrates a quadrant in the process of assembly. FIG. 16B is a diagram showing the assembled quadrant of FIG. 16A with a protective radome installed in accordance with an embodiment of the present disclosure. In an embodiment, four quadrants were installed at the Blossom Point location. In an embodiment, a radome fabricated using 25.4-mm-thick extruded polyurethane foam protects the assembled quadrant from unintentional damage during transport and installation, as shown in FIG. 16B. In an embodiment, four quadrants are connected in parallel and installed at a selected location (such as Blossom Point).

In an embodiment, rectenna arrays are fundamentally constrained by their maximum input power before destruction or degradation of the rectifying diodes. Fundamentally, solid-state device failure can be accelerated by three factors: excessive voltage, excessive current, and excessive temperature. Constraining one of these factors (vnoltage) could increase the margin of survivability as another of the factors (current) increases with increasing incident power density. Overvoltage protection devices such as transient voltage suppression (TVS) diodes and Zener diodes are sometimes used to limit rectenna output voltage in the event that the rectenna receives RF power while no DC load is connected. No information, however, is available on whether such protection devices also enhance the survivability of large rectenna arrays to excess power density encountered during ordinary operation—i.e., when a DC load is connected.

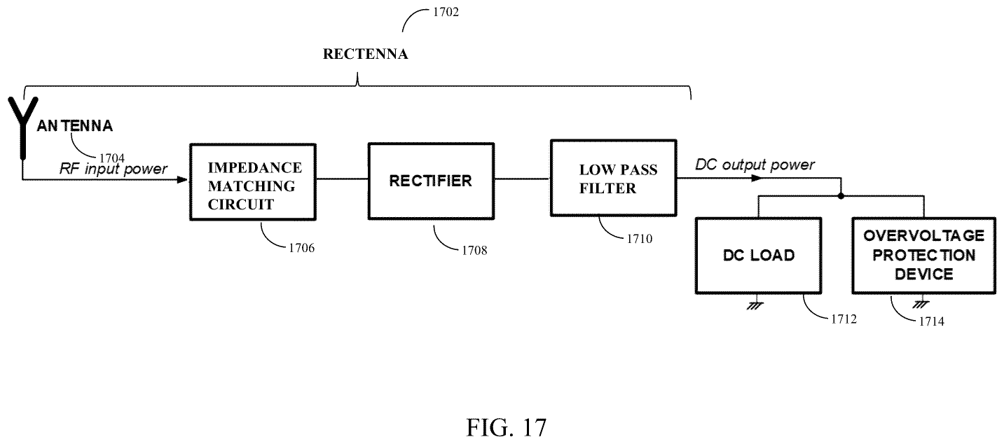

A schematic of this approach is shown in FIG. 17. FIG. 17 is a block diagram showing use of overvoltage protection in the DC load to enhance survivability to excessive RF input power in accordance with an embodiment of the present disclosure. In FIG. 17, rectenna 1702 includes antenna 1704, an impedance matching circuit 1706, a rectifier 1708, and a low pass filter (LPF) 1710. In an embodiment, voltage from DC output power from rectifier 1708 is limited by overvoltage protection device 1714 (e.g., in an embodiment, a diode), such as when no DC load 1712 is connected.

In an embodiment, overvoltage protection device (OPD) 1714 enables input power (e.g., the RF input power signal generated by antenna 1704) to be increased without destroying circuitry by increasing the failure threshold limit to input RF power. In an embodiment, overvoltage protection device 1714 begins to conduct when voltage output from rectifier 1708 reaches a predetermined DC level (e.g., predetermined by hardware specifications of overvoltage protection device 1714). In an embodiment, overvoltage protection device 1714 begins to conduct when voltage output from the DC output power generated by LPF 1710 reaches a predetermined DC level (e.g., predetermined by hardware specifications of overvoltage protection device 1714). In an embodiment, by doing that, overvoltage protection device 1714 alters the DC load that the rectifying diode (e.g., in DC load 1712) sees, thereby creating a mismatch condition at the rectifier diode where some of the RF power reflects back to the antenna 1704, thereby preventing the RF power from damaging the rectifying diode.

### 6. Exemplary Systems for Increasing Receive Power Handling

In an embodiment, the transmitter is used to beam power to the rectenna array shown in FIG. 16B. In an embodiment, the rectenna array is centered at (hRX+Δh)=5.5 m based on mechanical considerations at the test site. In an embodiment, reviewing manufacturer's specifications for the maximum input power of the MA4E1317, the estimated maximum power handling of the rectenna array (neglecting losses in the microstrip antenna and matching network) is 444 W/m².

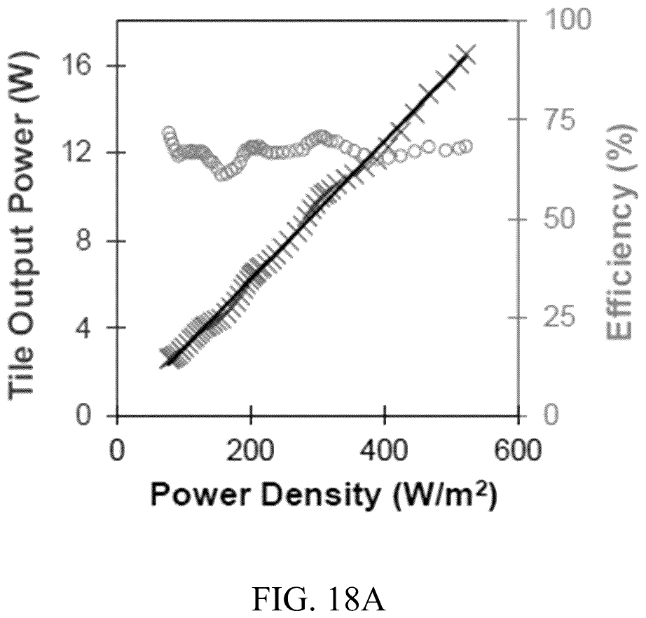

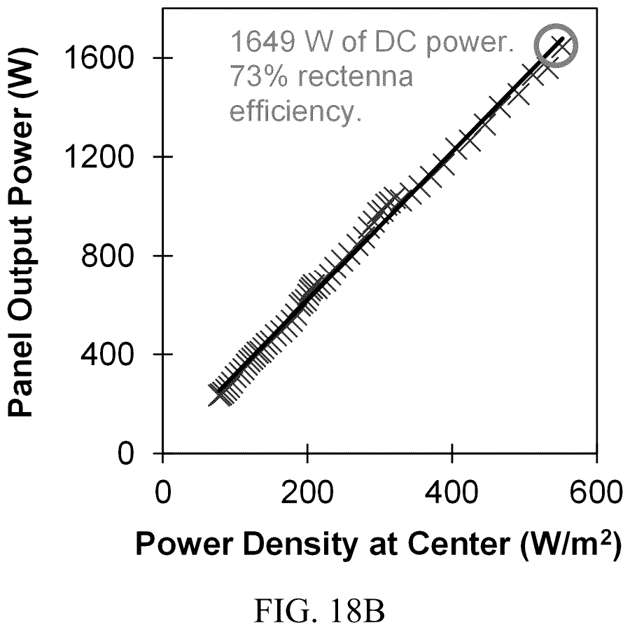

FIG. 18A is a diagram showing output power and efficiency for a single rectenna tile vs. incident power density in accordance with an embodiment of the present disclosure. In FIG. 18A, the small lines represent tile output power, the circles represent efficiency, and the large line represents a linear fit of the data.

In an embodiment, an individual rectenna tile is mounted in the center of the target area as the incident power density sweeps over a 98 to 524 W/m2 range. FIG. 18A shows the rectenna's measured output power across a 180 Ω load and the corresponding RF-to-DC conversion efficiency calculated by dividing the output power by the total power incident on the surface of the rectenna tile. In an embodiment, although not statistically representative, 16.5 W output power is achieved at a power density of 522 W/m2, corresponding to an RF-to-DC conversion efficiency of 68%. A peak efficiency of 71% is achieved at a power density of 304 W/m².

FIG. 18B is a diagram showing output power and efficiency for the complete rectenna array assembled using the components shown in FIGS. 16A and 16B vs. incident power density in accordance with an embodiment of the present disclosure. The line represents a linear fit of the data.

In an embodiment, repeating this experiment for the entire rectenna array achieves 1649 W output power delivered to a 30-Ω resistor, as shown in FIG. 18B for the incident power density shown in second diagram 1404 in FIG. 14. In an embodiment, integrating this power density over the rectenna aperture yields a total of 2265 W incident power. In an embodiment, the corresponding RF-to-DC conversion efficiency is 73%. This result compares well with the state of the art reported to date at X band. In an embodiment, repeating this experiment with the transmitter and receiver oriented for horizontal polarization achieves 1581 W of output power at an illumination condition yielding 2229 W of incident RF power, which corresponds to an RF-to-DC conversion efficiency of 71%. Note that sources of experimental error in this efficiency calculation could include the use of a calibrated horn to map the received power density in second diagram 1404 in FIG. 14, which may respond differently to multipath scattering in comparison to the microstrip patch elements in the rectenna.

In an embodiment, in the case of a MA4E1317 Schottky diode, the manufacturer is unable to provide reliability information beyond the 20 dBm maximum RF input power specification. However, since a variable-focus transmitter in accordance with an embodiment of the present disclosure can provide a controllable uniform high power density over a large receive aperture, it is possible to experimentally evaluate the impact of overvoltage protection on rectenna survivability in a realistic system test. In an embodiment, to do this, each of the four rectenna quadrants shown can be mounted, one at a time, on the receive tower at the center of the target area. In an embodiment, individual 1 μs pulses of incrementally increasing power are transmitted at each quadrant until damage/degradation is observed using an oscilloscope to monitor the rectenna output.

In an embodiment, the first quadrant in this test series has no overvoltage protection. In an embodiment, the second quadrant uses four 53-V TVS diodes (STMicroelectronics 1.5KE62A) to protect 4 groups of 5 rectenna tiles within the quadrant. In an embodiment, the third quadrant is protected by four 56-V Zener diodes (ON Semiconductor 1N5370BG). In an embodiment, the fourth quadrant is protected by shorting the rectenna output. In an embodiment, after each high power pulse, the short is removed and the output is checked for degradation at a nominal power density.

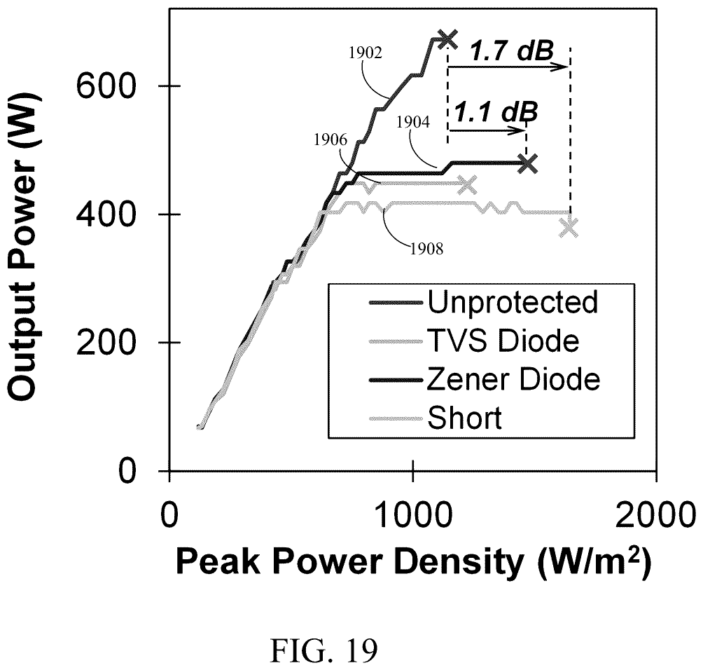

FIG. 19 is a diagram illustrating test to destruction for the four quadrants of the rectenna array comparing the effectiveness of the TVS diode, Zener diode, and short circuit protection for improving input RF power handling in accordance with an embodiment of the present disclosure. In FIG. 19, the top plot 1902 shows the unprotected effectiveness, the second plot from the top 1904 shows the effectiveness of the Zener diode, the third plot from the top 1906 shows the effectiveness of the TVS diode, and the fourth plot from the top 1908 shows the effectiveness of the short circuit protection.

In an embodiment, as shown in FIG. 19, the unprotected rectenna quadrant reaches an output power of 672 W before incurring damage, indicating that the output power achieved of the full array could have pushed significantly beyond 1.6 kW to as high as 2.7 kW before destruction. In an embodiment, while the TVS diode provides little improvement over the unprotected array, the array protected by the Zener diode fails at 1.1 dB higher input power density. In an embodiment, the 1.7 dB increase in power handling for the array protected by the short circuit establishes an upper bound on the performance of overvoltage protection devices, from the standpoint of response time and parasitic resistance.

In an embodiment, the results in FIG. 19 are statistically significant because, for example, each quadrant contains 4872 diodes, and the Schottky diodes in large rectenna arrays tend to “fail safe,” degrading gracefully as an ensemble until severe failure is reached. Given the duality between power amplifiers and rectifiers [31], a >1 dB increase in RF power handling can be understood as a substantial improvement in survivability.

### 7. Exemplary Advantages and Alternatives

Conventional power beaming systems have significantly elevated the transmit and/or receive apertures to avoid the effects of scattering from terrain. Embodiments of the present disclosure provide systems and methods that actually harness scattering from terrain to improve the beam focus, i.e., help to concentrate transmit power at the receive location.

Conventional power beaming systems have been designed to focus power for receivers at specific standoff distances in the near field or at receivers in the far field (i.e., infinity focus). Embodiments of the present disclosure provide a power beaming system with the ability to focus the beam at variable standoff locations. Embodiments of the present disclosure provide a system to enhance RF power handling using an overvoltage suppression circuit at the receiver's DC load.

In an embodiment, the reflector antenna can be replaced with a phased array or other spatially combined transmit array. In an embodiment, the reflector antenna can be replaced with a phased array that can create a variable parabolic phase shift over the transmit aperture to replace the mechanically adjusted feed used in our system. In an embodiment, the reflector antenna can be replaced with a phased array that can adapt the amplitude and/or phased of the phased array element to the terrain to enhance power at the target location via an optimization process for maximizing received power.

In an embodiment, methods in accordance with embodiments of the present disclosure can be combined with other phased array performance objectives, such as beam scanning. In an embodiment, a variety of electronic circuits can similarly protect the DC load of rectenna array from exceeding a maximum voltage in addition to exemplary electronic circuits discussed above.

### 8. Conclusion

It is to be appreciated that the Detailed Description, and not the Abstract, is intended to be used to interpret the claims. The Abstract may set forth one or more but not all exemplary embodiments of the present disclosure as contemplated by the inventor(s), and thus, is not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

While various embodiments of the present disclosure have been described above, it should be understood that they have been presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the above-described exemplary embodiments.

What is claimed is:

1. A system, comprising:
a reflector configured to transmit a signal to a rectenna;
a waveguide coupled to the reflector; and
a controller coupled to the waveguide, wherein the controller is configured to:
receive first information regarding power sampled from the reflector,
receive second information regarding power sampled at the rectenna,
determine, based on the first information and the second information, a positional adjustment for the rectenna, and
generate an instruction for the rectenna to adjust its position based on the positional adjustment.

2. The system of claim 1, further comprising:
a power meter coupled to the waveguide and the controller, wherein the power meter is configured to:
sample power from the reflector, and
generate the first information.

3. The system of claim 1, wherein the rectenna is coupled to a power meter, and wherein the power meter is configured to:
sample power from the rectenna, and
generate the second information.

4. The system of claim 1, wherein the positional adjustment comprises an adjusted tilt angle for the rectenna.

5. The system of claim 1, wherein the positional adjustment comprises an adjusted height for the rectenna.

6. The system of claim 1, wherein the positional adjustment comprises an adjusted height and an adjusted tilt angle for the rectenna.

7. The system of claim 1, wherein the controller is further configured to:
generate a plurality of instructions, wherein the plurality of instructions contain a plurality of respective height adjustments for the rectenna;
receive a plurality of power measurements from the rectenna corresponding to each height adjustment in the plurality of height adjustments; and
determine the positional adjustment based on the plurality of power measurements.

8. The system of claim 1, wherein the controller is further configured to:
generate a plurality of instructions, wherein the plurality of instructions contain a plurality of respective tilt angle adjustments for the rectenna;
receive a plurality of power measurements from the rectenna corresponding to each tilt angle adjustment in the plurality of tilt angle adjustments; and
determine the positional adjustment based on the plurality of power measurements.

9. A system, comprising:
a rectenna configured to receive a signal from a reflector; and
a controller coupled to the rectenna, wherein the controller is configured to:
receive first information regarding power sampled from the reflector,
receive second information regarding power sampled at the rectenna,
determine, based on the first information and the second information, a positional adjustment for the rectenna, and
generate an instruction for the rectenna to adjust its position based on the positional adjustment.

10. The system of claim 9, wherein the reflector is coupled to a waveguide, wherein a power meter is coupled to the waveguide, and wherein the power meter is configured to:
sample power from the reflector, and
generate the first information.

11. The system of claim 1, further comprising:
a power meter coupled to the rectenna, wherein the power meter is configured to:
sample power from the rectenna, and
generate the second information.

12. The system of claim 1, wherein the positional adjustment comprises an adjusted tilt angle for the rectenna.

13. The system of claim 1, wherein the positional adjustment comprises an adjusted height for the rectenna.

14. The system of claim 1, wherein the positional adjustment comprises an adjusted height and an adjusted tilt angle for the rectenna.

15. The system of claim 1, wherein the controller is further configured to:
generate a plurality of instructions, wherein the plurality of instructions contain a plurality of respective height adjustments for the rectenna;
receive a plurality of power measurements from the rectenna corresponding to each height adjustment in the plurality of height adjustments; and
determine the positional adjustment based on the plurality of power measurements.

16. The system of claim 1, wherein the controller is further configured to:
generate a plurality of instructions, wherein the plurality of instructions contain a plurality of respective tilt angle adjustments for the rectenna;
receive a plurality of power measurements from the rectenna corresponding to each tilt angle adjustment in the plurality of tilt angle adjustments; and
determine the positional adjustment based on the plurality of power measurements.

17. A system, comprising:
a reflector configured to transmit a signal;
a waveguide coupled to the reflector;
a first power meter coupled to the waveguide, wherein the first power meter is configured to sample power at the reflector an generate a first power sample;
a rectenna configured to receive the signal;
a second power meter coupled to the rectenna, wherein the second power meter is configured to sample power at the rectenna an generate a second power sample;
a controller coupled to the waveguide, wherein the controller is configured to:
receive the first power sample and the second power sample,
determine, based on the first power sample and the second power sample, a positional adjustment for the rectenna, and
send a signal to the rectenna to adjust its position based on the positional adjustment.

18. The system of claim 17, wherein the positional adjustment comprises an adjusted tilt angle for the rectenna.

19. The system of claim 17, wherein the positional adjustment comprises an adjusted height for the rectenna.

20. The system of claim 17, wherein the positional adjustment comprises an adjusted height and an adjusted tilt angle for the rectenna.
